(19) United States
(12) Patent Application Publication
(10) Pub. No.: US 2005/0268675 A1
(43) Pub. Date: Dec. 8, 2005

(54) Computer & electronics security system

(76) Inventor: Alexander Jean Tarlton Loudon, Oxnard, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/109,508

(22) Filed: Apr. 19, 2005

(30) Foreign Application Priority Data
Apr. 22, 2004 (CA) 2,464,703

(51) Int. Cl. E05B 73/00

(52) U.S. Cl. 70/58

(57) ABSTRACT

An apparatus for preventing theft of portable computer and electronics equipment using a novel “Cross-U Lock Block” design is an external containment structure not requiring any mounting system, or other device, connection, or securing substance on or in the protected device. The structural design, arrangement, and relationships, among all components function in the same manner for both custom made and standard sizes, to achieve an effective anti-theft device. The device has uniquely designed members which, when unassembled, nest together compactly for transport in the made to fit dual handle carrying case and which, when assembled over a relatively small, expensive portable electronic device and secured with a padlock form the durable and novel “Cross-U Lock Block” configuration, providing an effective, visually presentable, highly mobile and convenient method for the prevention of theft of said device.

### CLAIM TO PRIORITY

This application claims the benefit of Canadian Application No. 2,464,703, filed Apr. 22, 2004, entitled, “COMPUTER & ELECTRONICS SECURITY SYSTEM,” the entire contents of which is incorporated herein by reference.

### FIELD OF THE INVENTION

The present invention relates generally to the field of anti-theft devices for the protection of relatively small but expensive pieces of electronic equipment including portable laptop computers. More specifically, the present invention relates to an externally fitting locking apparatus with a novel “Cross-U Lock Block” design. The structural design, arrangement, and relationships, among all assembled components of the easy to assemble and transport invention, function in exactly the same manner at all sizes made, and there are several standard sizes as well as custom made sizes.

### BACKGROUND OF THE INVENTION

Computers and electronics have evolved rather rapidly from large, expensive, stationary machines, useable only by a few, to relatively small, portable machines, which are useable by many. In particular, the development of laptop computers, and related devices, with significant processing power has made computers and accessory electronic items available to the general population. It is now common for college, high school and even grade school students, as well as many employees at a variety of levels of in a wide range of companies, to have their own portable computer and transport and use it in a number of settings: at home; at work or school; and, in public. These valuable items are relatively small and easily transportable and an undesirable side effect of their proliferation is the fact that the theft of such items is a significant problem. Furthermore, because of the value of data stored within the devices (i.e., the software and data files) it is often the case that the time and cost associated with replacing stolen computers far outweighs their original purchase price.

A variety of devices have been developed to inhibit the theft of portable computer and electronics equipment. There are several personal computer security systems and anti-theft devices for electronics available to the public and known in the prior art. See, for example, Canadian Patent No. 2205171, Canadian Patent No. 2082649, Canadian Patent No. 2246139, Canadian Patent No. 2271368, Canadian Patent No. 2281466, U.S. Pat. No. 5,351,507, U.S. Pat. No. 5,836,183, U.S. Pat. No. 5,787,738, U.S. Pat. No. 5,642,634, U.S. Pat. No. 5,327,752, and U.S. Pat. No. 5,502,989.

Since portable computer and electronics equipment vary by design and size, and since such security systems are often configured in a manner requiring the protected device to have a compatible component(s) on or built into it which may or may not exist and may or may not be the right size, shape or type, and since they sometimes employ a “nail it down to the desk” method to be set up, such systems, as well as being unsightly and unprofessional looking, may not be effective at all times, in all places, for all users, especially for those who regularly transport and use their devices in different places. Since also, along with traditional locking means, some of these security systems employ anchors that adhere to the case of a valuable device through a “super-bonder” glue or other adhesive—which are easily overcome by professional thieves using simple tools to pry them off, and, since also many of these systems, even the ones with complex and novel locking means, use flexible cables and cables with relatively small diameters—which can easily be cut with an accessible tool a seasoned thief stealing an expensive item would have and use, such systems are ineffective and insufficient.

There also exists various electronic alarm, identification and recovery products that either alert owners when they have been tampered with, or assist in tracking stolen merchandise. Of questionable reliability, these devices are expensive and do little to prevent theft. They may assist in the recovery of stolen items, however once a computer has been stolen the damage is irreversible since computers can be dismantled and sold for their component parts and the cost to the owner has already been inflicted. In the unlikely event that the computer is recovered, replacement and rebuilding of the data has already been necessary.

The principal difficulty in such systems is providing an effective, visually presentable, and convenient method for securing the equipment and its contents at any time and in any location.

### SUMMARY OF THE INVENTION

The present invention aims to overcome, at least in part, some of the aforementioned problems. The assignee of this application has invented an externally fitting locking apparatus 20 with a novel “Cross-U Lock Block” design. Conveniently, in its various custom built and standard sizes, the structural design, arrangement, and relationships, among all assembled components of the invention, function in exactly the same manner. The primary objectives of this invention, which will be made salient via detailed review of the specifications and drawings are: to provide a durable, strong and secure system for preventing the theft of expensive mobile and portable computer equipment and electronics devices; to make said invention able to be used with any make, model, shape and size of such products to be protected; to make said product independent of the need for any mounting system, or other connection, configuration or substance on or in the protected device; to make said product easy to assemble, use, disassemble, store and transport; to make said product relatively professional in appearance; and, to make said system compatible with any standard padlock or combination lock on the market today.

The present invention is comprised of seven pieces plus its leather carrying case (8), as listed in Appendix A: “SECURITY DEVICE PIECES LIST” and introduced here. Each individual piece is made of welded, smoothed, coated mild steel, or a combination of similarly durable and strong materials. These seven pieces are labeled “U-Bar A” (1), “U-Bar B” (2), “Stake A” (3), “Stake B” (4), “Weave Bar” (5), “U-Lock Block” (6), and “Chain” (7). It is easily assembled and disassembled by one person in any location (see Appendix B: “EIGHT EASY STEPS TO ASSEMBLE THE CROSS-U ANTI-THEFT DEVICE” and see the following information in “Detailed Description of Preferred Embodiment” for a full explanation).

### BRIEF DESCRIPTION OF THE DRAWINGS

For a better understanding of the present invention and to show more clearly how it may be carried into effect, reference will now be made by way of example to the accompanying drawings which show the preferred embodiment of the present invention in which:

FIG. 1 is a front perspective view of piece Number 1, labeled “U-Bar A.”

FIG. 2 is a front perspective view of piece Number 2, labeled “U-Bar B.”

FIG. 3 is a blown up front perspective view of piece Number 3, labeled “Stake A.”

FIG. 4 is a blown up front perspective view of piece Number 4, labeled “Stake B.”

FIG. 5 is a blown up front perspective view of piece Number 5, labeled “Weave Bar” situated horizontally.

FIG. 6 is a blown up front perspective view of piece Number 6, labeled “U-Lock Block” situated horizontally.

FIG. 7 is a front perspective view of piece Number 7, labeled “Chain.”

FIG. 8 is a front perspective view of the empty carrying case to transport the unassembled items.

FIG. 9 is a front perspective view of a laptop—an example of an item which can be protected by this invention (not supplied with this invention).

FIG. 10 is a perspective view of a standard padlock—(not supplied with this invention).

FIG. 11 is an exploded front perspective view of the assembled apparatus over a laptop computer.

FIG. 12 is a front perspective view of U-Bar A and U-Lock Block in its assembled, unattached position. This configuration appears when the user completes STEP 1 of the apparatus assembly steps.

FIG. 13 is a front perspective view of U-Bar A and U-Lock Block in its assembled, attached to laptop position. This configuration appears when the user completes STEP 2 of the apparatus assembly steps.

FIG. 14 is a front perspective view of U-Bar A, U-Bar B and U-Lock Block in its assembled, attached to laptop position. This configuration appears when the user completes STEP 3 of the apparatus assembly steps.

FIG. 15 is a front perspective view of U-Bar A, U-Bar B, U-Lock Block and Stake B in its assembled, attached to laptop position. This configuration appears when the user completes STEP 4 of the apparatus assembly steps.

FIG. 16 is a front perspective view of U-Bar A, U-Bar B, U-Lock Block, Stake B and Weave Bar in its assembled, attached to laptop position. This configuration appears when the user completes STEP 5 of the apparatus assembly steps.

FIG. 17 is a front perspective view of U-Bar A, U-Bar B, U-Lock Block, Stake B, Weave Bar and Stake A in its assembled, attached to laptop position. This configuration appears when the user completes STEP 6 of the apparatus assembly steps.

FIG. 18 is a front perspective view of U-Bar A, U-Bar B, U-Lock Block, Stake B, Weave Bar, Stake A and attached open padlock in its assembled, attached to laptop position. This configuration appears when the user completes STEP 7 of the apparatus assembly steps.

FIG. 19 is a front perspective view of the preferred embodiment of the security system including the attached padlock plus all pieces of the device (U-Bar A, U-Bar B, U-Lock Block, Stake B, Weave Bar, Stake A, open padlock and chain) in its assembled, attached to laptop and attached to nearby immovable object position, non-secured.

FIG. 20 is a front perspective view of the preferred embodiment of the security system including the attached padlock plus all pieces in the device (U-Bar A, U-Bar B, U-Lock Block, Stake B, Weave Bar, Stake A, and chain) in its assembled, attached to laptop, and attached to nearby immovable object position, padlock closed. This configuration appears when the user completes STEP 8 of the apparatus assembly steps. The security apparatus is now secured and protecting said device.

FIG. 21 is a front perspective view of the carrying case with its disassembled members nested compactly within it and ready for transport.

Numeral references are employed to designate like parts throughout the various figures of the drawings. See Appendix C: “SUMMARY LIST OF FIGURES” for a charted summary of all figures, and see Appendix D: “SUMMARY LIST OF NUMBERS” for a list, with notes, of the respective numbered elements for all figures of the drawings.

### DETAILED DESCRIPTION OF THE PREFERRED EMBODIMENTS

Referring more specifically to the drawings, an embodiment of the invention will now be described in detail by way of example of its assembly on a laptop computer.

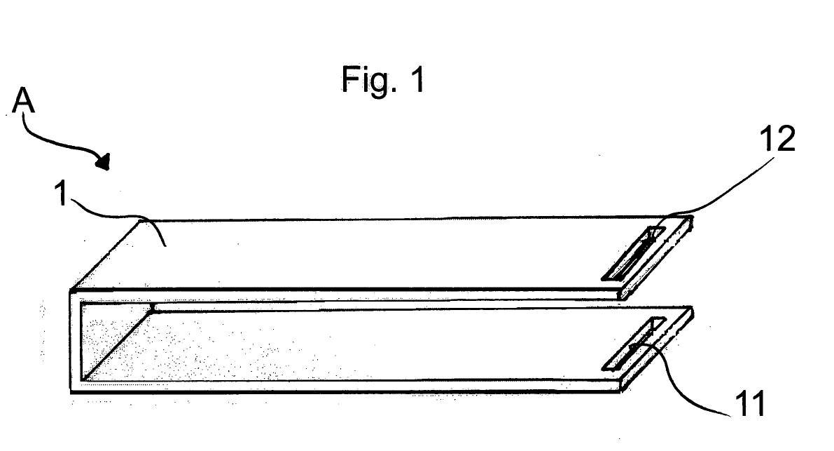

FIG. 1 is a front perspective view of piece Number 1, labeled “U-Bar A(1).” Referring to FIG. 1, the “U-Bar A” piece (1) according to the present invention has a shape like a “U” with two long sections, equal in length, and a connecting short section in between. This “U” shape fits over the width of the laptop (9), left to right of the user, and extends out slightly past the side of the laptop (9), to the right of the user. It is one solid piece. The short section is of a length just larger than the depth of the item being protected, to span it and allow sufficient room to accommodate for the bend. The longer sections of the piece are of the equal length to each other and have a series of rectangular holes at the end protruding out (11) on the lower portion relative to the laptop, and a matching series of rectangular holes at the end protruding out (12) on the upper portion relative to the laptop. The size of these slots (11, 12) is just large enough to allow the Stake A (3) or Stake B (4)—which are of the same dimensions, to slide through it securely. This piece of the apparatus is used first in assembly. It is slid through the U-Lock Block, (6) entering it (19) and exiting it (20) in Assembly Step 1 and then the two connected items are placed over the width of the laptop (9) in Assembly Step 2.

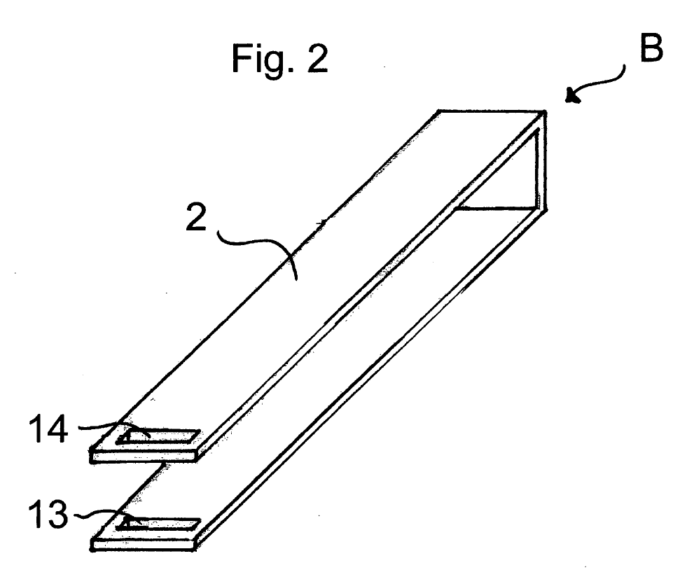

FIG. 2 is a front perspective view of piece Number 2, labeled “U-Bar B (2).” Referring to FIG. 2, the “U-Bar B” piece (2) according to the present invention has a shape like a “U” with two long sections, equal in length and a connecting short section in between. This “U” shape fits over the length of the laptop (9), back to front of the user, and extends out slightly past the front of the laptop (9), toward the user. It is one solid piece. The short section is of a length just larger than the depth of the item being protected, to span it and allow sufficient room to accommodate for the bend. The longer sections of the piece are of equal length to each other and have a series of rectangular holes at the end protruding out (13) on the lower portion relative to the laptop, and a matching series of rectangular holes at the end protruding out (14) on the upper portion relative to the laptop. The size of these slots (13, 14) is just large enough to allow the Stake B (4) or Stake A (3)—which are of the same dimensions, to slide through securely. On items that are square, U-Bar A (1) and U-Bar B (2) are the same length. On rectangular items their length is adjusted accordingly, as it is in the present example.

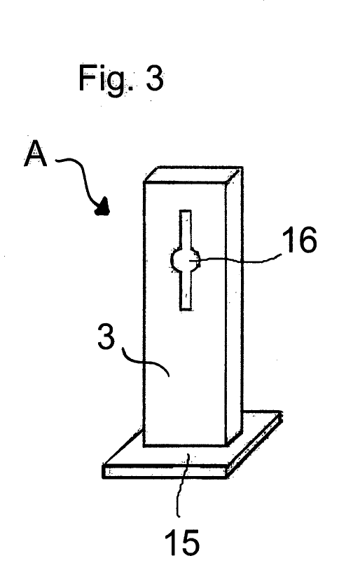

FIG. 3 is a blown up front perspective view of piece Number 3, labeled “Stake A (3).” Referring to FIG. 3, the “Stake A” piece (3) according to the present invention has a thick, round edged stopper bottom (15) at one end, so that when the Stake A (3) is vertically inserted through the rectangular slots (13, 14) in U-Bar B (2) the stopper bottom (15) secures it and prevents it from going through completely. The Stake A (3) also is of a thickness just smaller than the Tubular Opening (17) at the end of the Weave Bar (5), so that when it is vertically inserted through the rectangular slots (13, 14) in U-Bar B (2) at Assembly Step 6, and meets the horizontally assembled Weave Bar (5) which was assembled just prior in Assembly Step 5, it fits snugly into said Tubular Opening (17) such that the circle section of its Circle-Slit opening (16) is perfectly aligned with the Circular Openings (18a, 18b) at each side of the Tubular Opening (17) of the Weave Bar (5). This allows for the padlock shackle to be inserted through the aligned round areas of: Stake A Circle-Slit opening (16); and the Circular Openings (18a, 18b) of the Tubular Opening (17) of the Weave Bar (5) at Assembly Step 7. Note that Stake A (3) has the same circle-slit opening (16) as Stake B (4) despite not making use of the rectangular portion of the shape so that it is the same as Stake B (4), and thus they can be manufactured exactly the same.

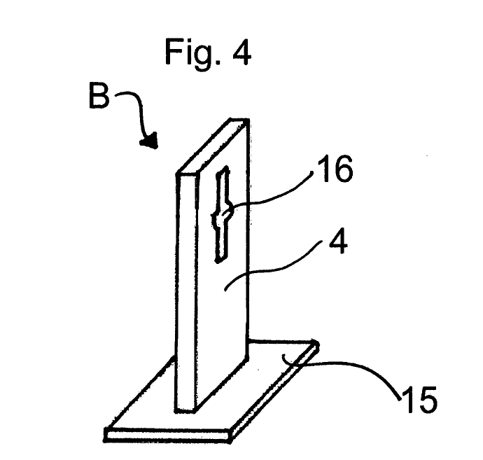

FIG. 4 is a blown up front perspective view of piece Number 4, labeled “Stake B (4).” Referring to FIG. 4, the “Stake B” piece (4) according to the present invention has a thick, round edged stopper bottom (15) at one end, so that when the Stake B (4) is vertically inserted through the rectangular slots (11, 12) in U-Bar A (1) at Assembly Step 4, the stopper bottom (15) secures it and prevents it from going through completely. With respect to thickness, Stake B (4) is the same as the above discussed Stake A (3). The Stake B (4) also has the same circle-slit opening (16) as Stake A (3) and in this case the circular portion of the shape is not employed, however the rectangular portion of the shape, which is thicker than the thickness of Stake B, is used by the Weave Bar (5) when the latter is inserted into the Stake B (4) circle-slit opening (16) at Assembly Step 5.

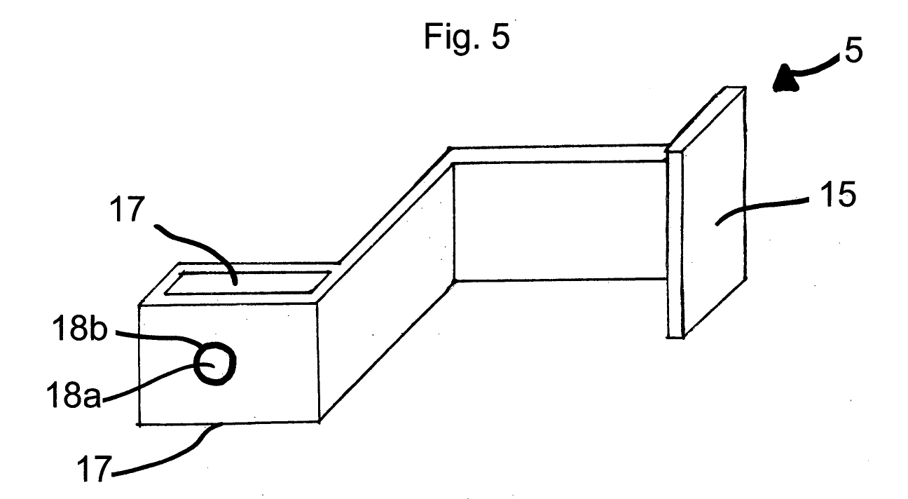

FIG. 5 is a blown up front perspective view of piece Number 5, labeled “Weave Bar (5)” situated horizontally. Referring to FIG. 5, the “Weave Bar” (5) piece according to the present invention, has a thick, round edged stopper bottom (15) at one end, so that when the Weave Bar (5) is horizontally inserted through the Circle-Slit opening (16) at the top of Stake B (4) at Assembly Step 5, the stopper bottom (15) secures it and prevents it from going through completely. The Weave Bar (5) is made of extremely strong material and has a size and an angled shape such that, once it is completely inserted, its Tubular Opening (17) is aligned and able to take the shape and size of Stake A (3) which is to be inserted next at Assembly Step 6, and also so that its Circular Openings (18a, 18b) at each of its sides perfectly aligns with the circle shape of the Circle-Slit opening (16) of the Stake A (3), thus enabling the padlock shackle entry at Assembly Step 7.

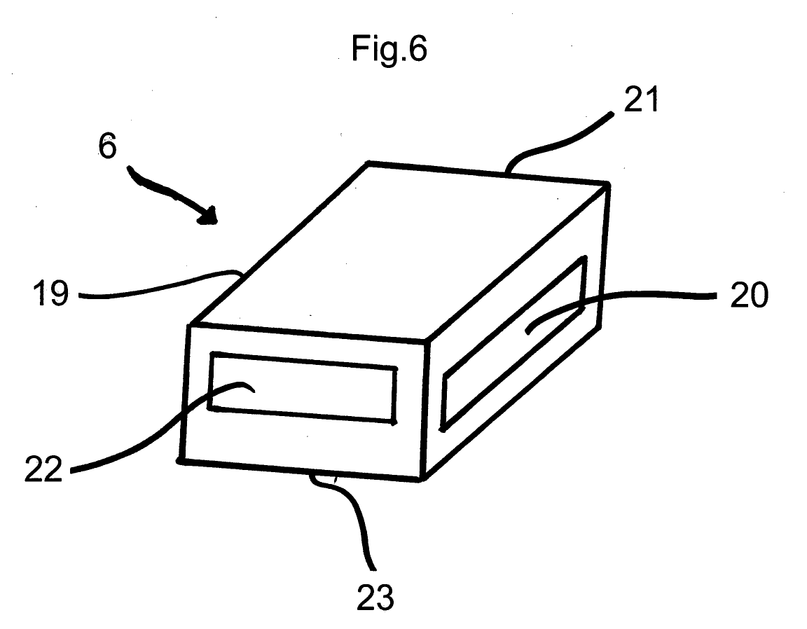

FIG. 6 is a blown up front perspective view of piece Number 6, labeled “U-Lock Block (6)” situated horizontally. Referring to FIG. 6, the “U-Lock Block” piece (6) according to the present invention, is made of extremely strong material and has a rectangular shape, a protective, attractive back cover (23) and has two side slots (19, 20) so that U-Bar A (1) can enter the side slot (19) and exit the other side slot (20) when it slides through the U-Lock Block (6) at Assembly Step 1. The U-Lock Block (6) also has a tubular opening (21, 22) so that U-Bar B (2) can enter it (21) and exit the other side of it (22) when it slides through the U-Lock Block (6) and U-Bar A (1)—which are now combined and placed on the laptop (9) from Assembly Step 2, at Assembly Step 3.

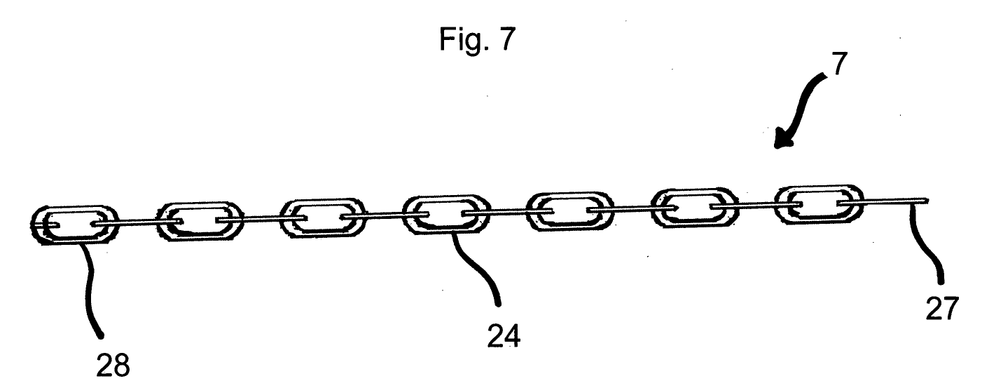

FIG. 7 is a front perspective view of piece Number 7, labeled “Chain (7).” Referring to FIG. 7, the “Chain” (7) according to the present invention, is a standard thick, sturdy link chain of a width sufficient to require a machine to cut, and of a length long enough to wrap around a nearby immovable object and have Chain Link End A (27) and Chain Link End B (28) enter the padlock at Assembly Step 8. Said chain is also encased in a sturdy, attractive leather material to prevent scratches and damage and for aesthetic purposes.

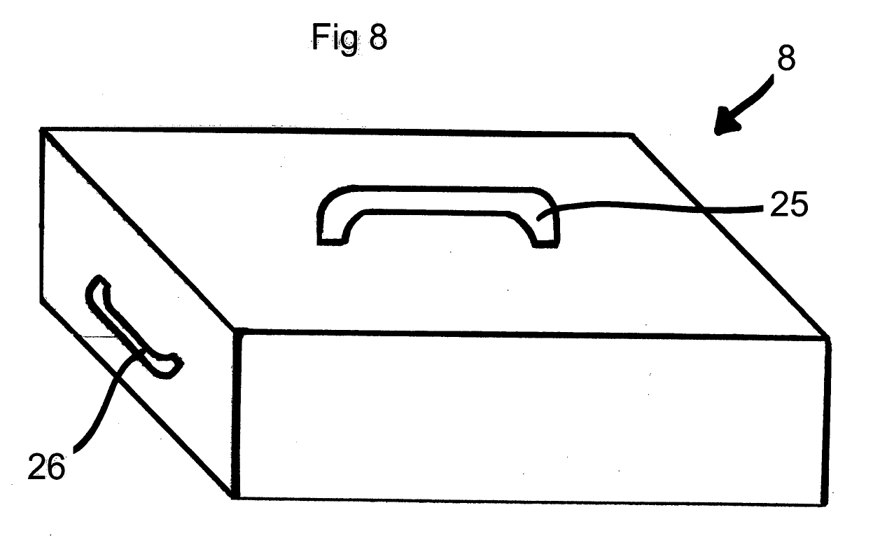

FIG. 8 is a front perspective view of the empty carrying case (8) to transport the unassembled items. Referring to FIG. 8, the “Carrying Case” (8) is an attractive leather case with a horizontal top handle (25) and a vertical top handle (26), which holds and transports the nested, compact disassembled items.

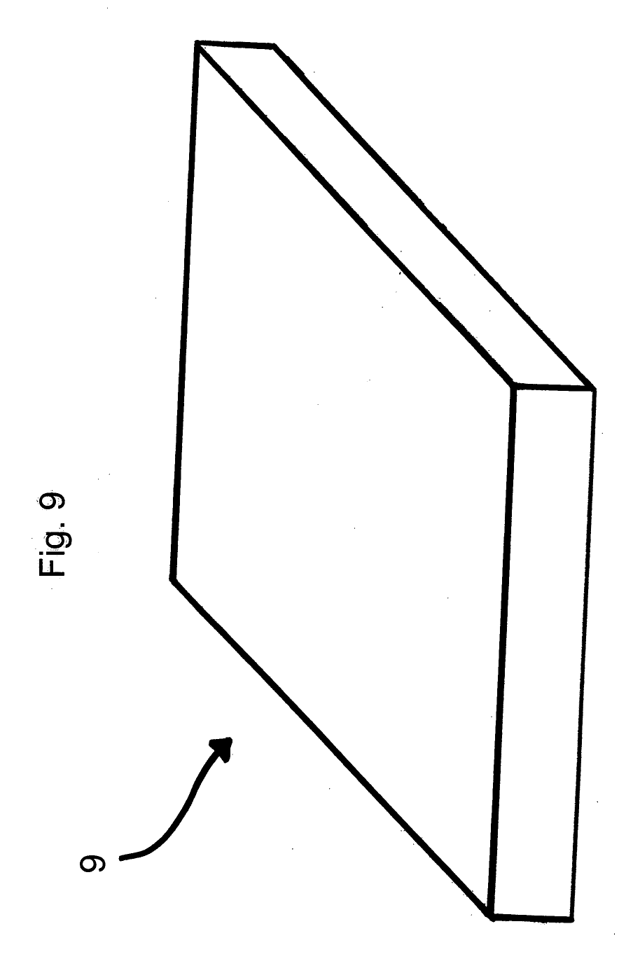

FIG. 9 is a front perspective view of a laptop (9)—an example of an item, which can be protected by this invention (not supplied with this invention). Referring to FIG. 9, the laptop (9) according to the present invention is one example of a relatively expensive item able to be protected by said computer and electronics security system.

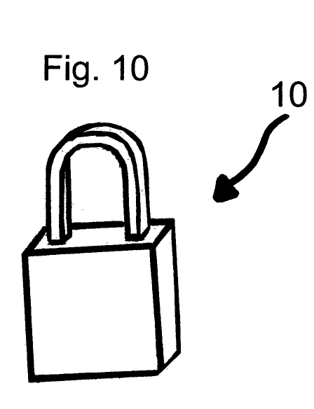

FIG. 10 is a perspective view of a standard padlock (10)—(not supplied with this invention). Referring to FIG. 10, the standard padlock (10), according to the present invention, is a standard market padlock for use with the invention and not provided with said invention. It is placed on the assembled apparatus at Assembly Step 7 and secured with the chain (7) attached at Assembly Step 8.

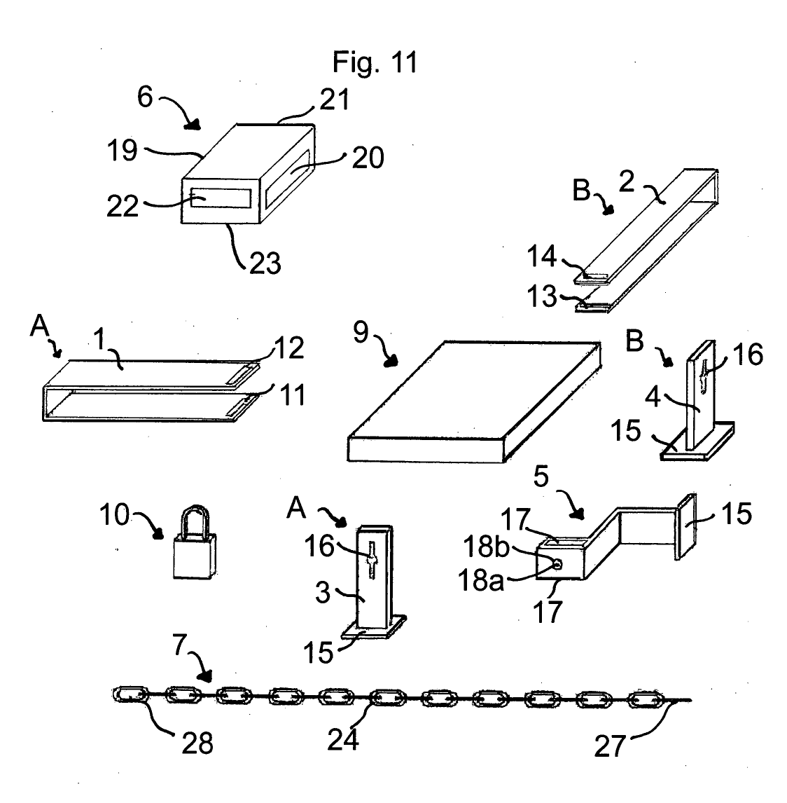

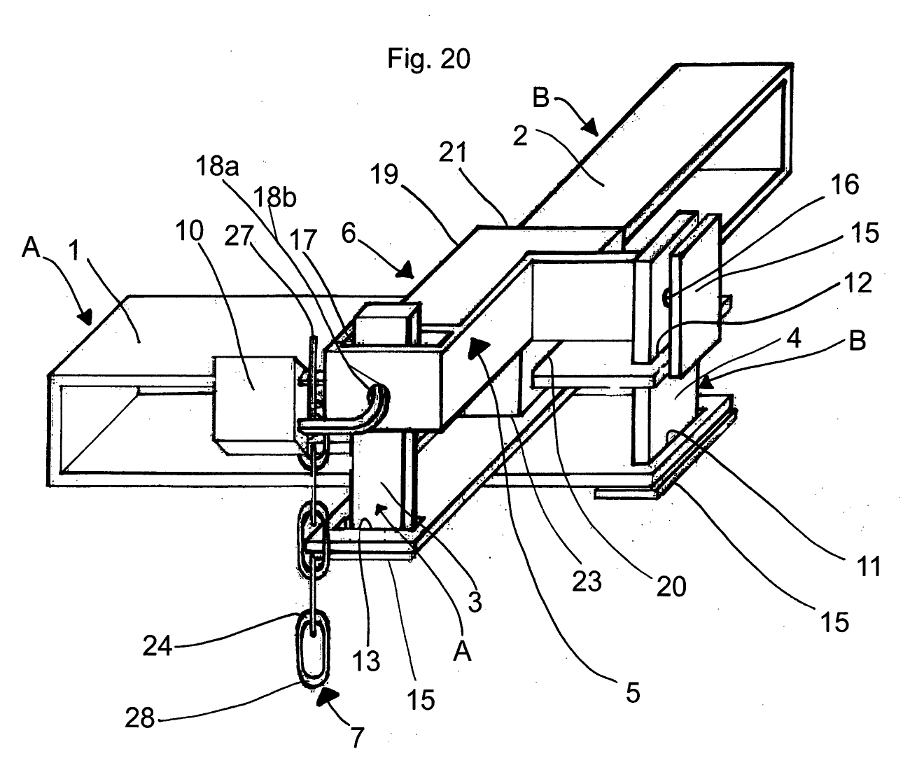

FIG. 11 is an exploded front perspective view of the assembled apparatus over a laptop computer (9). Referring to FIG. 11, each piece (1, 2, 3, 4, 5, 6, 7) of the device and the padlock (10) is exploded in its correct place at its correct angle and facing in its proper direction. The Eight Easy Steps to Assemble the Cross-U Anti Theft Device, which are listed in Appendix B, will now be discussed in detail and in order in the following Figures: 12; 13; 14; 15; 16; 17; 18, and 19 and the final, assembled, secured apparatus is discussed and appears as FIG. 20.

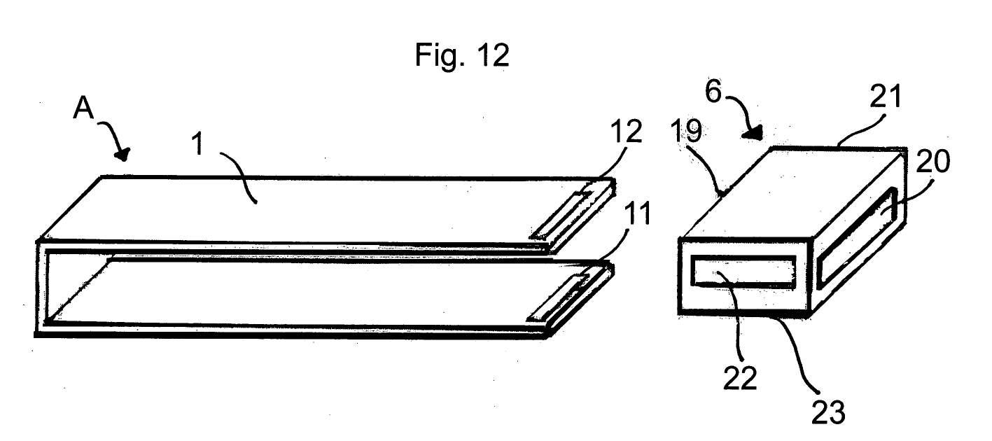

FIG. 12 is a front perspective view of U-Bar A (1) and U-Lock Block (6) in its assembled, unattached position. This configuration appears when user completes STEP 1 of the apparatus assembly steps. Referring to FIG. 12, there is shown an example embodiment of the partially assembled security device according to the invention, showing the pieces labeled: “U-Bar A” (1); and “U-Lock Block” (6), and making salient the Assembly Step #1: “Slide U-Bar A through the U-Lock Block.”

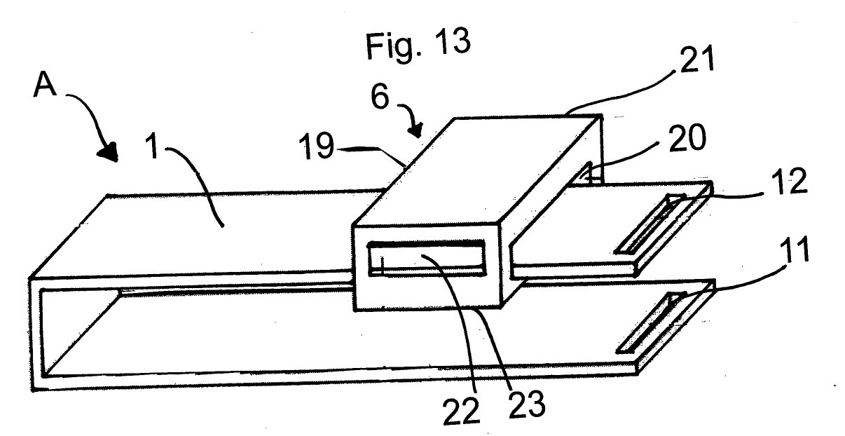

FIG. 13 is a front perspective view of U-Bar A (1) and U-Lock Block (6) in its assembled, attached to laptop (9) position. This configuration appears when the user completes STEP 2 of the apparatus assembly steps. Referring to FIG. 13, there is shown an example embodiment of the partially assembled security device according to the invention, showing the pieces labeled: “U-Bar A” (1); and “U-Lock Block” (6); and showing the laptop (9) to be protected, and making salient the Assembly Step #2: “Place the connected U-Bar A and U-Lock Block over the item to be protected so that the U-Lock Block is on the right side of the user, the left side of the laptop.”

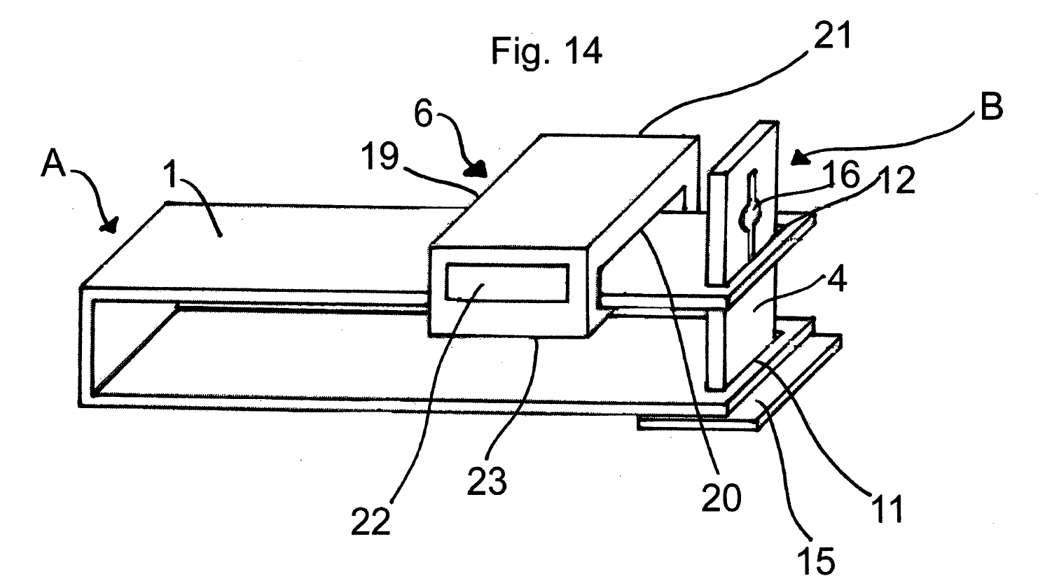

FIG. 14 is a front perspective view of U-Bar A (1), U-Bar B (2) and U-Lock Block (6) in its assembled, attached to laptop position. This configuration appears when the user completes STEP 3 of the apparatus assembly steps. Referring to FIG. 14, there is shown an example embodiment of the partially assembled security device according to the invention, showing the pieces labeled: “U-Bar A” (1); “U-Lock Block” (6); “U-Bar B” (2); and showing the laptop (9) to be protected, and making salient the Assembly Step #3: “Slide U-Bar B from the back of the laptop to the front toward the user, and through the opening of the U-Lock Block now positioned on the laptop.”

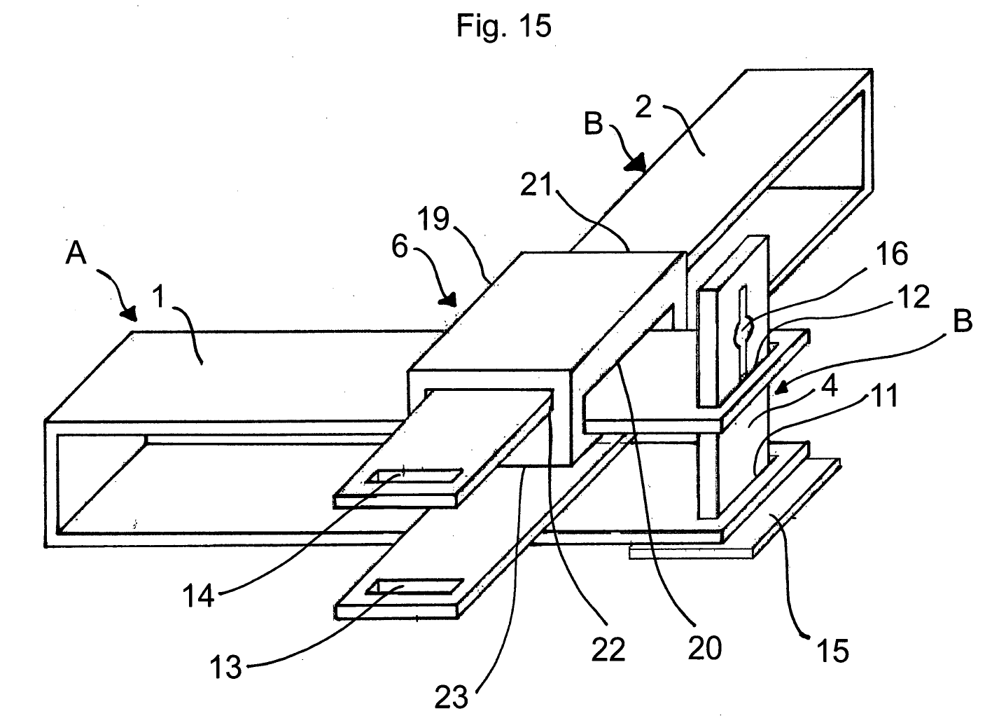

FIG. 15 is a front perspective view of U-Bar A (1), U-Bar B (2), U-Lock Block (6) and Stake B (4) in its assembled, attached to laptop (9) position. This configuration appears when user completes STEP 4 of the apparatus assembly steps. Referring to FIG. 15, there is shown an example embodiment of the partially assembled security device according to the invention, showing the pieces labeled: “U-Bar A” (1); “U-Lock Block” (6); “U-Bar B” (2); Stake B (4); and showing the laptop (9) to be protected, and making salient the Assembly Step #4: “Insert Stake B vertically through the lower and then upper slots of U-Bar A.”

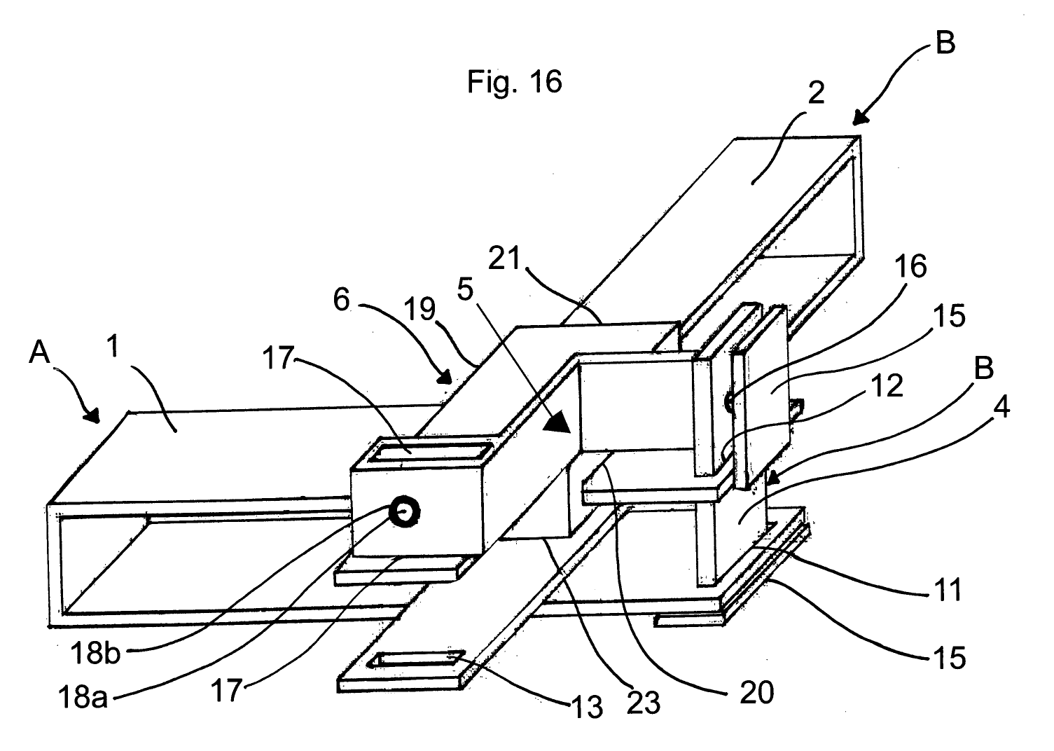

FIG. 16 is a front perspective view of U-Bar A (1), U-Bar B (2), U-Lock Block (6), Stake B (4) and Weave Bar (5) in its assembled, attached to laptop (9) position. This configuration appears when the user completes STEP 5 of the apparatus assembly steps. Referring to FIG. 16, there is shown an example embodiment of the partially assembled security device according to the invention, showing the pieces labeled: “U-Bar A” (1); “U-Lock Block” (6); “U-Bar B” (2); Stake B (4); “Weave Bar” (5); and showing the laptop (9) to be protected, and making salient the Assembly Step #5: “Fully insert Weave Bar horizontally through opening at top of Stake B.”

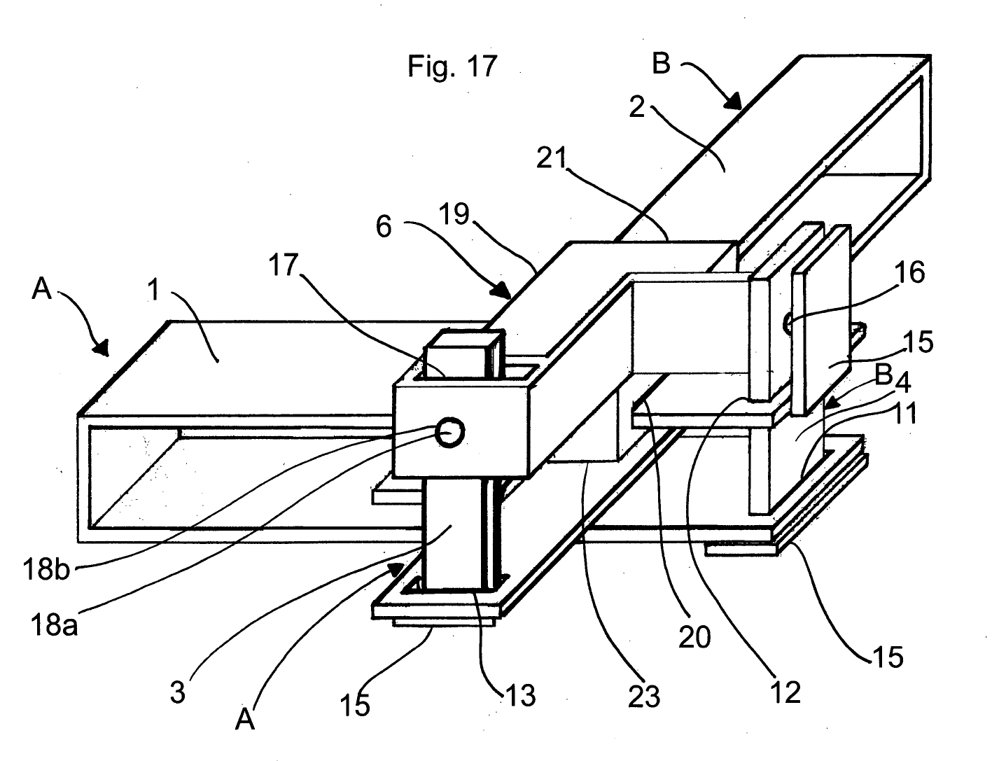

FIG. 17 is a front perspective view of U-Bar A (1), U-Bar B (2), U-Lock Block (6), Stake B (4), Weave Bar (5) and Stake A (3) in its assembled, attached to laptop position. This configuration appears when the user completes STEP 6 of the apparatus assembly steps. Referring to FIG. 17, there is shown an example embodiment of the partially assembled security device according to the invention, showing the pieces labeled: “U-Bar A” (1); “U-Lock Block” (6); “U-Bar B” (2); Stake B (4); “Weave Bar” (5); Stake A (3); and showing the laptop (9) to be protected, and making salient the Assembly Step #6: “Insert Stake A vertically through the lower and then upper slots of U-Bar B and then through the tubular horizontal opening of the Weave Bar so that the opening on Stake A is perfectly aligned with the opening on the tube of the Weave Bar.”

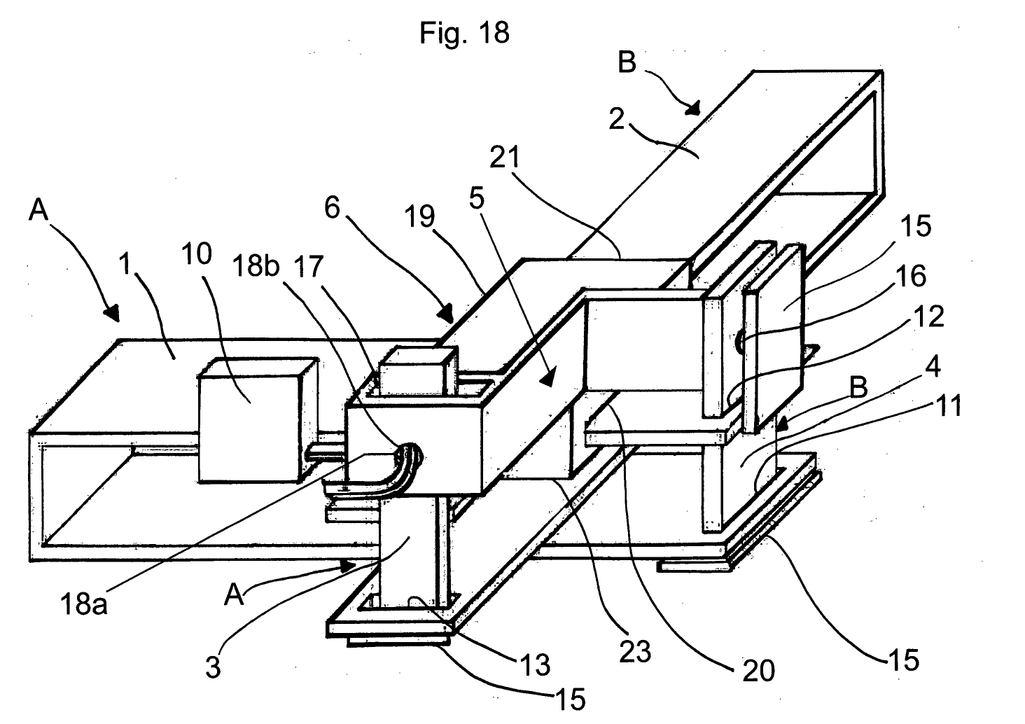

FIG. 18 is a front perspective view of U-Bar A (1), U-Bar B (2), U-Lock Block (6), Stake B (4), Weave Bar (5), Stake A (3) and attached open padlock (10) in its assembled, attached to laptop (9) position. This configuration appears when user completes STEP 7 of the apparatus assembly steps. Referring to FIG. 18, there is shown an example embodiment of the partially assembled security device according to the invention, showing the pieces labeled: “U-Bar A” (1); “U-Lock Block” (6); “U-Bar B” (2); Stake B (4); “Weave Bar” (5); Stake A (3); and showing the padlock (10), and the laptop (9) to be protected, and making salient the Assembly Step #7: “Insert padlock through the aligned openings on Stake A and the Weave Bar.”

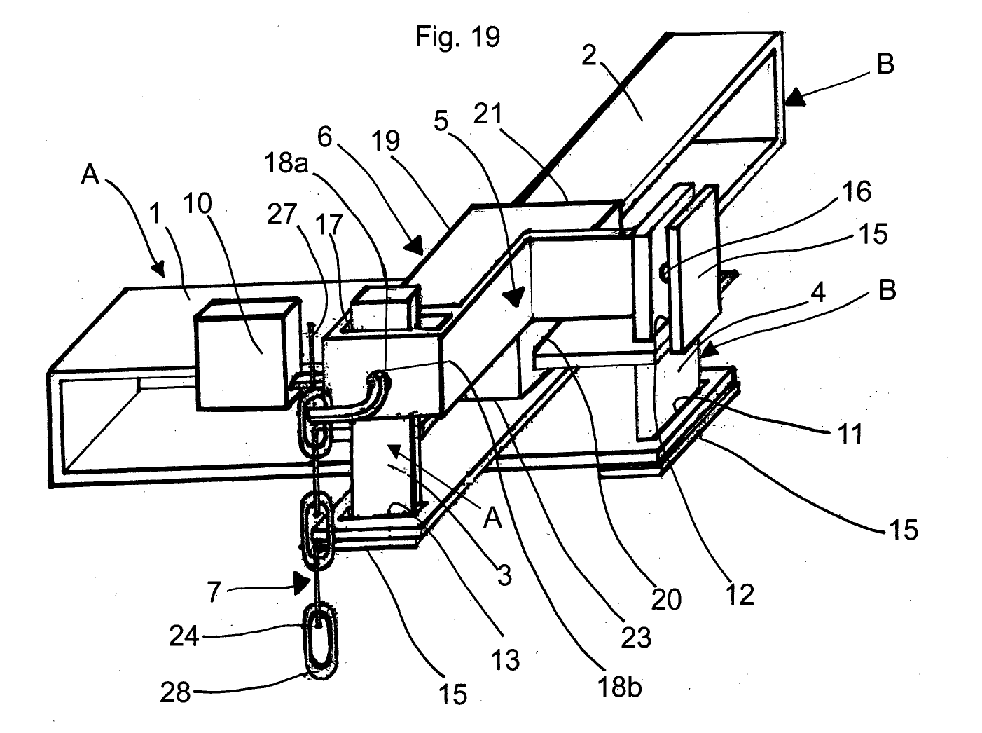

FIG. 19 is a front perspective view of the preferred embodiment of the security system including the attached padlock plus all pieces of the device (U-Bar A [1], U-Bar B [2], U-Lock Block [6], Stake B [4], Weave Bar [5], Stake A [3], open padlock [10] and chain [7]) in its assembled, attached to laptop (9) and attached to nearby immovable object position, non-secured. Referring to FIG. 19, there is shown an example embodiment of the partially assembled security device according to the invention, showing the pieces labeled: “U-Bar A” (1); “U-Lock Block” (6); “U-Bar B” (2); Stake B (4); “Weave Bar” (5); Stake A (3); “Chain” (7); and showing the padlock (10), and the laptop (9) to be protected, and making salient the Assembly Step #8: “Wrap chain around a nearby immovable object, inserting each end of chain through the padlock and close padlock. The anti-theft device is now secured.”

FIG. 20 is a front perspective view of the preferred embodiment of the security system including the attached padlock (10) plus all pieces in the device (U-Bar A [1], U-Bar B [2], U-Lock Block [6], Stake B [4], Weave Bar [5], Stake A [3], and chain [7]) in its assembled, attached to laptop (9), and attached to nearby immovable object position, padlock closed. This configuration appears when user completes STEP 8 of the apparatus assembly steps. The security apparatus is now secured and protecting said device. Referring to FIG. 20, there is shown an example embodiment of the fully assembled and secured security device protecting a laptop computer according to the invention. In its properly assembled and secured state, it provides complete protection from theft. In its essence: the laptop computer cannot be taken because it is attached to a nearby immovable object with the chain; the chain cannot be removed because of the secured padlock; the padlock cannot be removed because it is locked and strong; the U-Lock Block cannot be removed because it is held in place by the locked on U-Bars; the U-Bars cannot be slid off because each is held in place by the other and by the U-Lock Block, and by Stake A and Stake B, which are in turn held in place by their respective stopper ends and by the Weave Bar; and finally the Weave Bar is, in turn, held in place by the padlock and unique configuration held at one end by its tubular opening into which Stake A was inserted into, and at the other end by its stopper bottom.

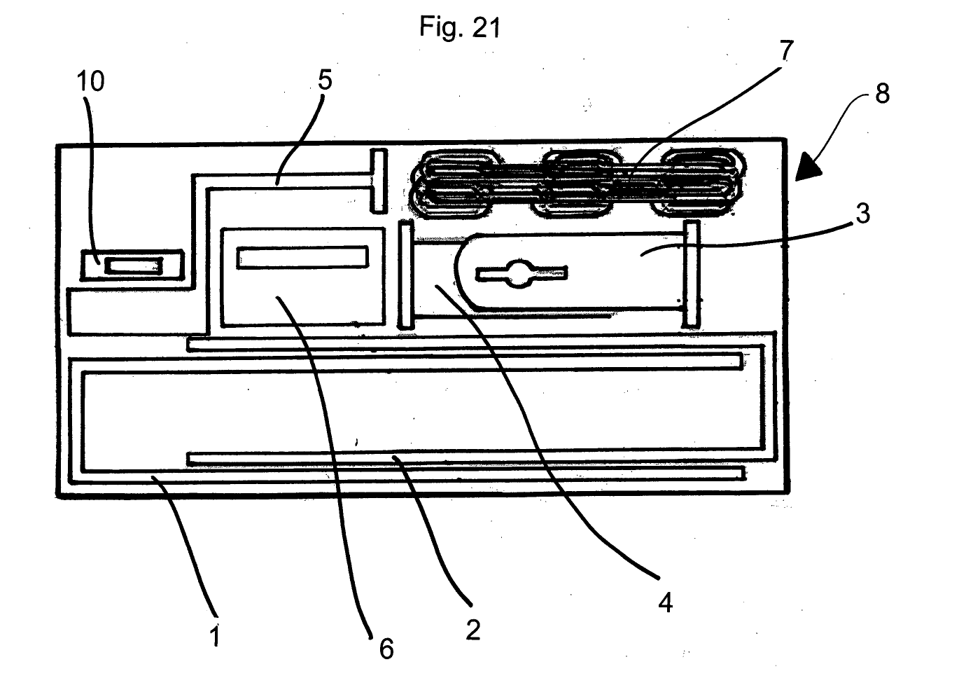

FIG. 21 is a front perspective view of the carrying case (8) with its disassembled members nested compactly within it and ready for transport. Referring to FIG. 21, there is shown the “Carrying Case” (8) nesting all disassembled parts (1, 2, 3, 4, 5, 6, 7) and the padlock (10) compactly.

The invention being thus described can be varied in a number of ways, for example, said invention can have two “Lock Blocks,” one below and one above said item being protected, and “U-Lock Blocks” in alternative positions, for additional security, to accommodate larger sizes and for other reasons. Other variations of said invention can contain multiple U-Bars, U-Lock Blocks, Stakes and Weave Bars of various adjusted sizes and related aspects, to enable unique shaped or sized objects to be protected including polygonal, curved, spherical, cylindrical, round items and the like. The invention being thus described in one embodiment in detail herein, it will be apparent to those skilled in the art that the same may be varied in many ways without departing from the spirit and scope of the invention. Any and all such modifications are intended to be included within the scope of the following claims.

### Appendices

### Appendix A: Security Device Pieces List

| MEMBER # | NAME |
|---|---|
| 1 | U-BAR A |
| 2 | U-BAR B |
| 3 | STAKE A |
| 4 | STAKE B |
| 5 | WEAVE BAR |
| 6 | U-LOCK |
| | BLOCK |
| 7 | CHAIN |
| 8 | CARRY CASE |

### Appendix B

### Eight Easy Steps to Assemble the Cross-U Anti-Theft Device

1. Slide U-Bar A through the U-Lock Block.

2. Place the connected U-Bar A and U-Lock Block over the item to be protected so that the U-Lock Block is on the right side of the user, the left side of the laptop.

3. Slide U-Bar B from the back of the laptop to the front toward the user, and through the opening of the U-Lock Block now positioned on the laptop.

4. Insert Stake B vertically through the lower and then upper slots of U-Bar A.

5. Fully insert Weave Bar horizontally through opening at top of Stake B.

6. Insert Stake A vertically through the lower and then upper slots of U-Bar B and then through the tubular horizontal opening of the Weave Bar so that the opening on Stake A is perfectly aligned with the opening on the tube of the Weave Bar.

7. Insert padlock through the aligned openings on Stake A and the Weave Bar.

8. Wrap chain around a nearby immovable object, inserting each end of chain through the padlock and close padlock. The anti-theft device is now secured.

### Appendix C: “Summary List of Figures”

| | |
|---|---|
| 1 | U-BAR A |
| 2 | U-BAR B |
| 3 | STAKE A |
| 4 | STAKE B |
| 5 | WEAVE BAR |
| 6 | U-LOCK BLOCK |
| 7 | CHAIN |
| 8 | CARRYING CASE - EMPTY |
| 9 | LAPTOP |
| 10 | STANDARD PADLOCK |
| 11 | ALL MEMBERS ASSEMBLED, EXPLODED VIEW OVER LAPTOP |
| 12 | U-BAR A ATTACHED TO U-LOCK BLOCK |
| 13 | COMBINED U-BAR A AND U-LOCK BLOCK OVER LAPTOP |
| 14 | U-BAR B ATTACHED TO COMBINED U-BAR A AND U-LOCK BLOCK OVER |
| | LAPTOP |
| 15 | STAKE B ATTACHED TO COMBINED U-BAR A, U-BAR B, & U-LOCK |
| | BLOCK OVER LAPTOP |
| 16 | WEAVE BAR ATTACHED TO COMBINED STAKE B, U-BAR A, U-BAR B, |
| | AND U-LOCK BLOCK OVER LAPTOP |
| 17 | STAKE A ATTACHED TO COMBINED WEAVE BAR, STAKE B, U-BAR B, U- |
| | BAR A AND U-LOCK BLOCK OVER LAPTOP |
| 18 | OPEN PADLOCK ATTACHED TO COMBINED STAKE A, WEAVE BAR, |
| | STAKE B, U-BAR B, U-BAR A, AND U-LOCK BLOCK OVER LAPTOP |
| 19 | OPEN PADLOCK ATTACHED TO CHAIN ENDS, & COMBINED STAKE A, |
| | WEAVE BAR,STAKE B,U-BAR B,U-BAR A,& U-LOCK BLOCK OVER |
| | LAPTOP |
| 20 | CLOSED PADLOCK ATTACHED TO BOTH CHAIN ENDS (WHICH IS |
| | SECURED TO AREA), ANT) COMBINED STAKE A, WEAVE BAR, STAKE B, |
| | U-BAR B, U-BAR A, & U-LOCK BLOCK OVER LAPTOP DEVICE SECURED. |
| 21 | CARRY CASE - FILLED WITH PIECES OF APPARATUS |

### Appendix D: “Summary List of Numbers”

| NUM- | | |
|---|---|---|
| BER | NAME OF ITEM | COMMENTS |
| 1 | U-BAR A | Contains numbers: 11, 12 |
| 2 | U-BAR B | Contains numbers: 13, 14 |
| 3 | STAKE A | Contains numbers: 15, 16 |
| 4 | STAKE B | Contains numbers:15, 16 |
| 5 | WEAVE BAR | Contains numbers: 15, 17, |
| | | 18a, 18b, |
| 6 | U-LOCK BLOCK | Contains numbers: 19, 20, |
| | | 21, 22, 23 |
| 7 | CHAIN | Contains numbers: 24, 27, |
| | | 28 |
| 8 | CARRY CASE | Contains numbers: 25, 26 |
| 9 | LAPTOP | Used for example. |
| 10 | STANDARD PADLOCK | Not included with device. |
| 11 | BOTTOM SLOTS ON U-BAR A | PART OF number: 1 |
| 12 | TOP SLOTS ON U-BAR A | PART OF number: 1 |
| 13 | BOTTOM SLOTS ON U-BAR B | PART OF number: 2 |
| 14 | TOP SLOTS ON U-BAR B | PART OF number: 2 |
| 15 | ROUND EDGED STOPPER | ON: 3, 4, 5 |
| | BOTTOM | |
| 16 | CIRCLE SLIT OPENING | ON: 3, 4 |
| 17 | WEAVE BAR TUBED END | ON: 5 |
| 18a | CIRCULAR OPENING A ON | ON: 5 |
| | TUBE | |
| 18b | CIRCULAR OPENING B ON | ON: 5 |
| | TUBE | |
| 19 | SIDE SLOT 1 ON U-LOCK | ON: 6 |
| | BLOCK | |
| 20 | SIDE SLOT 2 ON U-LOCK | ON: 6 |
| | BLOCK | |
| 21 | OPEN TUBE AREA 1 ON | ON: 6 |
| | U-LOCK BLOCK | |
| 22 | OPEN TUBE AREA 2 ON | ON: 6 |
| | U-LOCK BLOCK | |
| 23 | PROTECTIVE BACK COVER | ON: 6 |
| 24 | PROTECTIVE CHAIN CASING | ON: 7 |
| 25 | CARRY CASE HANDLE 1 | ON: 8 |
| 26 | CARRY CASE HANDLE 2 | ON: 8 |
| 27 | CHAIN END OPEN LINK A | ON: 7 |
| 28 | CHAIN END OPEN LINK B | ON: 7 |

NOTES ON ITEMS ABOVE:
i.) #15 is large enough and thick enough to prevent the member it is a part of from sliding through or being broken off.
ii.) #16 is an opening shaped like a combination of a rectangle and a circle. The circle is large enough to have a standard padlock shackle go through it. The rectangle is large enough to have the weave bar go through it. This shape is visually represented in figures 3 and 4.
iii.) #17 is a vertical tube opening with a circle opening at each side (#18a, #18b), the vertical tube opening of which is just greater in size than the width and thickness of Stake A and Stake B so stake A or B can go through it and be held strongly with locked padlock in place, and the circle openings of which are large enough to have a standard padlock shackle go through them. This tube opening with circular openings on each side is visually represented in figure 5.
iv.) #19 is a side slot on the U-Lock Block where U-Bar A slides in during assembly Step 1.
v.) #20 is a side slot on the U-Lock Block where U-Bar A slides out during assembly Step 1.
vi.) #21 is an opening in the tube of the U-Lock Block where U-Bar B slides in during assembly Step 3.
vii.) #22 is an opening in the tube of the U-Lock Block where U-Bar B slides out of during assembly Step 3.

1. An anti-theft device for an electronic device comprising:
a first retaining member having a first closed end and a first pair of legs defining a first open end;
a second retaining member having a second closed end and a second pair of legs defining a second open end;
at least one receiver member having a first aperture and a second aperture arranged in a non-parallel orientation, the first aperture adapted for slidable insertion of one of the first legs and the second aperture adapted for slidable insertion of the one of the second legs;
a first closure member for closing the first open end;
a second closure member for closing the second open end; and
an interconnecting member for removably joining the first closure member and the second closure member such that the first retaining member and the second retaining member cooperatively retain the electronic device.

2. The anti-theft device of claim 1, wherein each of the first pair of legs comprises a first bore adjacent the first open end and wherein the first closure member slidingly inserts through the first bores for closing the first open end.

3. The anti-theft device of claim 1, wherein each of the second pair of legs comprises a second bore adjacent the second open end and wherein the second closure member slidingly inserts through the second bores for closing the second open end.

4. The anti-theft device of claim 1, wherein the interconnecting member comprises an interconnecting bore and the second closure member comprises a locking bore wherein a locking device slidingly inserts through the interconnecting bore and the locking bore for lockably retaining the electronic device.

5. The anti-theft device of claim 4, further comprising a securing member for wrapping about a fixed object, said securing member being closed about the fixed object by capture in the locking device.

6. The anti-theft device of claim 5, wherein the securing member is selected from the group comprising: a chain and a cable.

7. The anti-theft device of claim 1, wherein the first retaining member, the second retaining member, the receiver member, the first closure member, the second closure member and the interconnecting member are fabricated from a material selected from the group comprising: mild steel, stainless steel, aluminum and a rigid polymer.

8. The anti-theft device of claim 1, comprising at least two receiving members wherein each receiving member is individually adapted for slidable receipt of one of the first legs and one of the second legs such that the first retaining member and the second retaining member cooperatively retaining the electronic device.

9. The anti-theft device of claim 1, wherein the electronic device comprises a portable computer.

10. The anti-theft device of claim 1, wherein the first retaining member and the second retaining member cooperatively, transversely retain the electronic device.

11. A method for securing a portable computer comprising:
positioning a first retaining member about a portion of the portable computer;
positioning a second retaining member about a portion of the portable computer, the second retaining member positioned in a generally transverse relation to the first retaining member;
interconnecting the first retaining member and the second retaining member with a linking member such that the portable computer is captively retained by the first retaining member and the second retaining member.

12. The method of claim 11, further comprising:
locking the linking member to one of the first retaining member or second retaining member with a locking device to lockably retain the portable computer.

13. The method of claim 12, further comprising:
securing the portable computer to an immovable object.

14. A security device for a portable electronic device comprising:
a pair of generally U-shaped members arranged in generally perpendicular relation such that a portable electronic device is at least partially surrounded by the generally U-shaped members;
a receiving member adapted to receivingly interconnect with the generally U-shaped members;
a pair of closure members wherein each closure member closes an open end on one of the generally U-shaped members; and
a linkage member adapted to interconnect between the closure members such that the portable electronic device is secured within the generally U-shaped members.

15. The security device of claim 14, wherein the electronic portable device comprises a portable computer.

16. The security device of claim 14, further comprising a locking member adapted to lockingly interconnect the linkage member to the generally U-shaped members.

17. The security device of claim 16, further comprising a securing member adapted for lockable capture by the linkage member and wherein the securing member is further adapted for securing to a fixed object so as to prevent theft of the portable electronic device.

18. The security device of claim 17, wherein the securing member is selected from the group comprising: a chain and a cable.

19. The security device of claim 14, wherein the generally U-shaped members, the receiving member, the closure members and the linkage member are fabricated from a material selected from the group comprising: mild steel, stainless steel, aluminum and a rigid polymer.

20. The security device of claim 14, wherein the receiving member comprises a pair of non-parallel apertures, wherein each aperture selectively interfaces with one of the generally U-shaped members.
